(19) United States
(12) Patent Application Publication
(10) Pub. No.: US 2006/0153231 A1
(43) Pub. Date: Jul. 13, 2006

(54) Method for transmitting data signals by means of virtually linked partial signals via synchronous data networks

(76) Inventor: Andreas Fricke, Munchen (DE)

Correspondence Address: Siemens Corporation;Intellectual Property Department, 170 Wood Avenue South, Iselin, NJ, 08830, US

(21) Appl. No.: 10/529,740

(22) PCT Filed: Aug. 18, 2003
(86) PCT No.: PCT/DE03/02755

§ 371 Date: Oct. 11, 2005

(30) Foreign Application Priority Data
Sep. 30, 2002 (DE) 10245638.0

(51) Int. Cl. G06F 9/46; H04J 3/14; H04J 3/22; H04J 3/04

(52) U.S. Cl. 370/468; 370/225; 370/535; 718/105

(57) ABSTRACT

The inventive method serves to transmit data signals by means of virtually linked partial signals via synchronous data networks. To this end, the transmission capacity formed by the number of virtually linked partial signals is greater than the minimally required transmission capacity for transmitting the data signal.

### CROSS REFERENCE TO RELATED APPLICATIONS

This application is the US National Stage of International Application No. PCT/DE2003/002755, filed Aug. 18, 2003 and claims the benefit thereof. The International Application claims the benefits of German application No. 10245638.0 filed Sep. 30, 2002, both applications are incorporated by reference herein in their entirety.

### FIELD OF THE INVENTION

This invention relates to a method for transmitting data signals by means of virtually linked partial signals via synchronous data networks.

### BACKGROUND OF THE INVENTION

Synchronous data networks, for example the Synchronous Digital Hierarchy, SDH for short, the Synchronous Optical Network, SONET for short, or the Optical Transport Network, OTN for short, are used for transmitting data signals or data packets such as, for example, Ethernet, Fiber channel or FICON data packets, etc. In these schemes the data signals are often inserted or mapped into virtually linked partial signals for transmission. In this arrangement the virtually linked partial signals form an overall signal which contains the data signal.

This enables the bandwidth to be configured so as to achieve an economical optimum. The virtual linking of partial signals, otherwise referred to as virtually concatenated containers, also allows the individual partial signals to be transmitted over different physical paths.

The so-called Link Capacity-Adjustment Scheme, LCAS for short, permits individual virtually linked partial signals to be added and removed dynamically.

### SUMMARY OF THE INVENTION

If a secure data connection is desired, the safeguarding or protection of a transmission path is ensured by means of what is known as 1+1 protection such as, for example, 1+1 multiplex section protection, 1+1 MSP for short. In this scheme the signal is duplicated at the transmit end and one signal is transmitted over each of two physical paths to the receive end. At the receive end a decision is made on which of the two signals will be used. Usually the signal exhibiting the better quality is used.

A relatively large amount of network capacity is tied up by this provisioning of a second, redundant path for the safeguarding or protection of a data connection; in the example double the amount of transmission capacity is required.

The object of the present invention is to disclose a more economical solution approach for protecting data connections that use virtually linked partial signals.

This object is achieved by the claims.

The advantage of the method is that substantially less transport capacity must be made available for data connections requiring protection.

Advantageous embodiments of the invention are specified in the dependent claims.

An exemplary embodiment serving to illustrate the invention is shown in the drawing and is described below.

### BRIEF DESCRIPTION OF THE DRAWINGS

FIG. 1 shows a block diagram for an arrangement for performing the method according to the invention.

FIG. 2 shows the block diagram according to FIG. 1 in an error state.

### DETAILED DESCRIPTION OF THE INVENTION

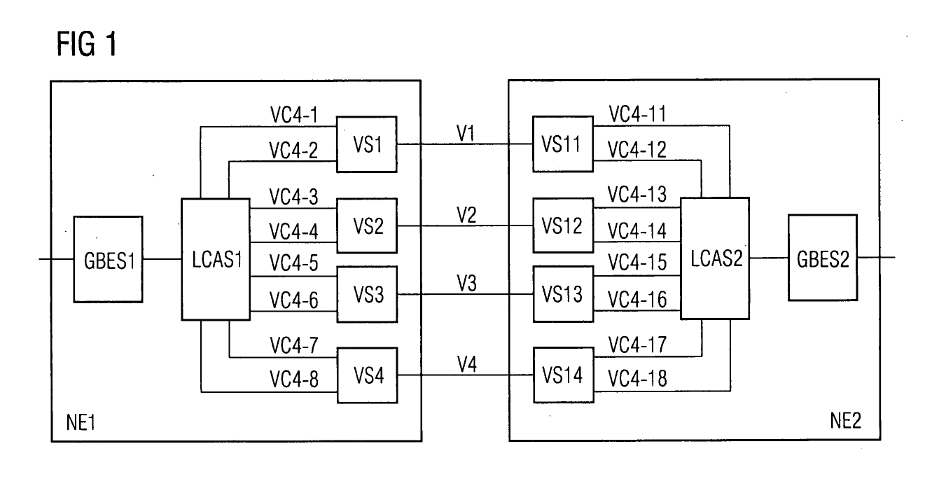

FIG. 1 shows a first network element NE1. An input of the network element NE1 leads to a Gigabit Ethernet interface unit GBES1 which processes a Gigabit Ethernet signal supplied through the input and emits said signal at its output. The output is connected to the input of a Link Capacity Adjustment Scheme unit LCAS1. Said unit subdivides the supplied signal into a plurality of partial signals (into eight signals VC4-1 to VC4-8 in the example) which are emitted at their eight outputs. Two outputs of the Link Capacity Adjustment Scheme unit LCAS1 are connected in each case to one connection interface unit VS1 to VS4. The outputs of the four connection interface units VS1 to VS4 are connected via four connections V1 to V4 to a second network element NE2 which is structured similarly to the first network element. Each of the four connections is supplied to one of four connection interface units VS11 to VS14, two outputs of each of which are connected to a Link Capacity Adjustment Scheme unit LCAS2, which combines the supplied eight signals VC4-11 to VC4-18 into one signal and at its output supplies the latter to a Gigabit Ethernet interface GBES2, which emits a Gigabit Ethernet signal at its output as an output signal of the network element NE2.

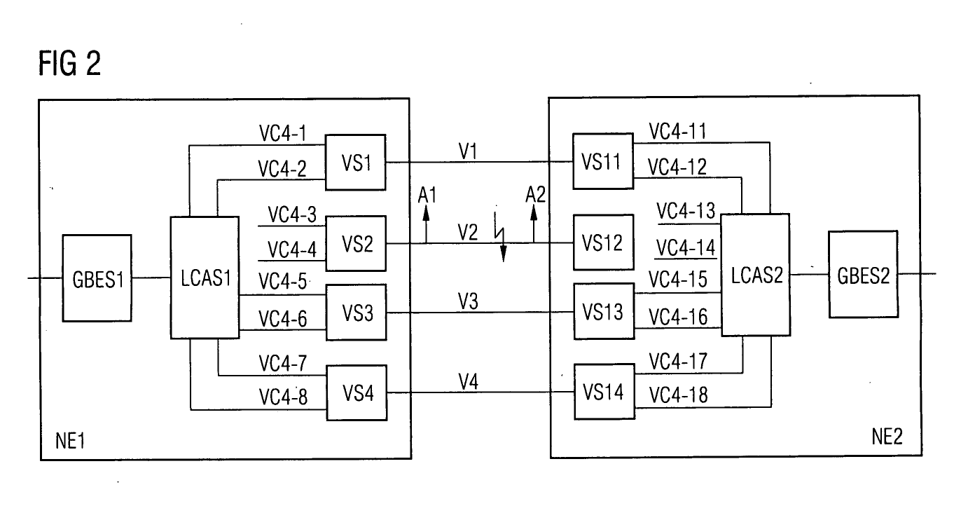

FIG. 2 shows an arrangement according to FIG. 1 in an error state. In this case the second connection V2 is interrupted. This is signaled by an alarm A1 at the first network element NE1 and by an alarm A2 at the second network element NE2. Thereupon the partial signals VC4-3 and VC4-4 and VC4-13 and VC4-14 are no longer used, as indicated in the diagram by two missing connections in each case between the Link Capacity Adjustment Scheme unit LCAS1 and the connection interface unit VS2 and the Link Capacity Adjustment Scheme unit LCAS2 and the connection interface unit VS12.

The method is explained in more detail below.

Data packets of a Gigabit Ethernet signal which have a bit rate of about 1 Gbit/s are continuously inserted or mapped via the Gigabit Ethernet interface GBES1 and the Link Capacity Adjustment Scheme unit LCAS1 into virtually linked SDH or SONET partial signals.

With the SDH or SONET method, the maximum possible payload of a container in the case of virtually linked partial signals is about 150 Mbit/s. This container is designated VC4. Accordingly, a Gigabit Ethernet signal can be inserted into seven VC4 containers.

In the present case the signal is inserted, not into seven, but into eight virtually linked containers, represented in the example by the eight partial signals VC4-1 to VC4-8 or VC4-11 to VC4-18, at the hierarchy level VC4; in short, mapped into 8×VC4vc. Said eight virtually linked partial signals are transmitted by means of the connection interfaces VS1 to VS4 or VS11 to VS14 via four different physical paths V1 to V4, with one path transmitting two containers or 2×VC4 in each case. If one of the four signal paths is interrupted, V2 in the example, an alarm is reported by said signal path or a predefined quality threshold value or a corresponding quality criterion is undershot. For example, an alarm or quality criterion such as Loss of Signal, LOS for short, Loss of Frame, LOF for short, Signal Degrade, SD for short, Excessive Bit Error Rate, EXBER for short, Alarm Indication Signal, AIS for short, or similar is detected and reported for the two VC-4 partial signals of the affected route or path. This is indicated in the example by the alarms A1 and A2. Said alarms or said criteria are used so that the Link Capacity Adjustment Scheme, LCAS for short, will no longer use the two affected partial signals for the insertion, at the transmit end, of the data signal into the partial signals or for the mapping method. At the receive end, said partial signals are also no longer used for the combining of partial signals into a Gigabit Ethernet signal. In the example this relates to the signals VC4-3 and VC4-4 on the one hand and VC4-13 and VC4-14 on the other, which are represented in FIG. 2 by the missing connection between the Link Capacity Adjustment Scheme unit LCAS1 and the connection interface unit VS2 on the one hand and the Link Capacity Adjustment Scheme unit LCAS2 and the connection interface unit VS12 on the other.

In this safeguarding or protection scenario, 6×VC4vc are still available for the transmission.

As a result the capacity of the connection is reduced in an error situation, but said capacity remains error-free. This restriction is not noticeable in practice and can therefore be tolerated. If necessary a further VC4 can be added to the 6×VC4vc in the protection scenario in order to restore the full transmission bandwidth, for which 7×VC4vc l are required.

The method according to the invention consists in a data signal being inserted into a plurality of partial signals, the overall capacity of the partial signals being greater than that of the data signal. This means that somewhat more transport capacity is used than is necessary, but not so much capacity as would be required for conventional 1+1 protection. The partial signals are transmitted over different physical paths.

If a route or path fails, the partial signal of said route or path is no longer used. As a result, depending on the number of paths and the number of partial signals, somewhat less or the precisely required transport capacity is available totally free of error. A certain undercapacity can be tolerated by many applications. If necessary a further channel can now be attached.

The advantage of the method is that less additional capacity is required for protecting the connection and the protection switchover is performed very rapidly, more or less in real time.

Said protection switchover could also be executed by a management system, although this has the disadvantage of a greater outage and switchover time.

The method according to the invention further consists in the individual measurement or determination of the signal quality of virtually linked partial signals. By this means a specific quality criterion is determined which is used for removing one or more virtual partial signals if they fall below a predefined quality threshold value. Removing or adding partial signals can be carried out by means of the Link Capacity Adjustment Scheme, LCAS for short.

1.-3. (canceled)

4. A method for protected transmission of a data signal via synchronous data networks, the method comprising:
subdividing the data signal into a plurality of virtually linked partial signals; and
transmitting the virtually linked partial signals via a plurality of data channels, wherein
at least one data channel more than needed is used for transmitting the data signal, wherein
the data signal is subdivided into partial signals transported at a lower data rate and transmitted using all data channels, and wherein
the data signal is subdivided again and allocated to remaining data channels, if there is a problem with a data channel.

5. The method as claimed in claim 4, wherein the partial signals or groups of partial signals or the data channels or groups of data channels are transmitted via different physical connections.

6. The method as claimed in claim 4, wherein the signal quality of each partial signal is determined individually and if at least one of the partial signals falls below a predefined quality threshold value, following appropriate feedback the partial signal in question is removed or disabled at the transmit and receive end.

7. The method as claimed in claim 5, wherein the signal quality of each partial signal is determined individually and if at least one of the partial signals falls below a predefined quality threshold value, following appropriate feedback the partial signal in question is removed or disabled at the transmit and receive end.

8. The method as claimed in claim 4, wherein the overall capacity of the virtually linked partial signals is greater than that of the data signal.

9. A method for protected transmission of a data signal via synchronous data networks, the method comprising:
subdividing the data signal into a plurality of virtually linked partial signals;
determining a number of data channels needed for transmitting the virtually linked partial signals based on characteristics of the data signal; and
transmitting the virtually linked partial signals via a plurality of data channels, wherein
the plurality of data channels exceeds the determined number of data channels by at least one, wherein
the overall capacity of the virtually linked partial signals is greater than that of the data signal, and wherein
all data channels are used for transmitting.

10. The method as claimed in claim 9, wherein the partial signals or groups of partial signals or the data channels or groups of data channels are transmitted via different physical connections.

11. The method as claimed in claim 9, wherein the signal quality of each partial signal is determined individually and if at least one of the partial signals falls below a predefined quality threshold value, following appropriate feedback the partial signal in question is removed or disabled at the transmit and receive end.

12. The method as claimed in claim 10, wherein the signal quality of each partial signal is determined individually and if at least one of the partial signals falls below a predefined quality threshold value, following appropriate feedback the partial signal in question is removed or disabled at the transmit and receive end.

13. The method as claimed in claim 9, wherein the data signal is subdivided again and allocated to remaining data channels, if there is a problem with a data channel.
